(19) United States
(12) Patent Application Publication
(10) Pub. No.: US 2011/0033154 A1
(43) Pub. Date: Feb. 10, 2011

(54) Connector for Multiple Optical Fibers and Installation Apparatus

(75) Inventors: Eric Weynant, Montreal (CA); Patrick Zivojinovic, Montreal (CA); Eric Menu, Montreal (CA); Alex Fraser, St-Romuald (CA); Mathieu Bergeron, St-Ferreol-Les-Neiges (CA)

Correspondence Address: Sunstein Kann Murphy & Timbers LLP, 125 SUMMER STREET, BOSTON, MA, 02110-1618, US

(73) Assignee: PHASOPTX INC., Montreal, QC (CA)

(21) Appl. No.: 12/664,525

(22) PCT Filed: Jun. 16, 2008
(86) PCT No.: PCT/CA2008/001147

§ 371 Date: Oct. 21, 2010

Related U.S. Application Data
(60) Provisional application No. 60/943,965, filed on Jun. 14, 2007.

(51) Int. Cl. G02B 6/38

(52) U.S. Cl. 385/62

(57) ABSTRACT

The present invention comprises a connector comprising shape memory material such as a shape memory alloy, an optical fiber conduit and an axial stress opening traversing the connector from the connector surface to the fiber conduit and along at least a portion of a longitudinal length of the connector. The fiber conduit is dimensioned for optical fibers and to secure two optical fibers in abutment alignment for light signal transmission from one fiber to the other, with minimal attenuation and for securing the fibers without crushing or other damage to the fibers. In another embodiment, the present invention relates to a method of bringing optical fibers in abutment connection for signal conduction using a connector as above, wherein a wedging force is applied to the stress opening, whereby the wedging force will induce separation of the side walls of the slot and expansion of the fiber conduit for insertion of optical fibers and their abutment connection and securing of the fibers in abutment connection, when the wedging force is removed. Alternatively, a force may be applied to either side of the stress opening to again expand the opening and fiber conduit for the purpose of placement of optical fibers within the fiber conduit. Removal of the force will allow retention of the fibers in abutment connection of the fibers. In a still further embodiment, the present invention relates to an apparatus which applies a wedging force to a stress opening for expansion of a fiber conduit and insertion of optical fibers and their retention, light transmission abutment and connection in a connector as above.

### FIELD OF INVENTION

The present invention relates to an optical fiber connection device that allows end-to-end alignment of two optical fibers or the end-to-end alignment of multiple pairs of optical fibers, permitting a light signal to pass from one fiber to the other fiber with minimal attenuation and to an installation apparatus for positioning optical fibers in the connection device.

### BACKGROUND

One approach described for optical fiber connection for good signal conduction is by abutment of the ends of optical fibers as described in U.S. Pat. No. 7,066,656; U.S. Pat. No. 7,121,731 and PCT/CA2004/001855 (WO 2005/040876, published May 6, 2005). The connection devices and methods according to the above approach rely on the exploitation of shape memory materials such as shape memory alloys, all as described in the aforesaid, which are all incorporated by reference herein.

Connection by the above approach is achieved by relying on deformation by a suitable means such as by heating and cooling or application and removal of mechanical force, or any suitable combination, all as described. Suitable connectors are also produced by known techniques, including milling by mechanical or laser means. The above approach is applicable to all mechanical splice, optical connector, optical adaptor, ferrule and like devices.

The present invention relates to a simple and elegant connector and like device and method of use of a connector or like device for connection of optical fibers by abutment. The connector and method of the present invention also permits the connection of multiple pairs of fibers, using a single connector device. The present invention also relates to a simple and elegant apparatus for use with the connector and method of the present invention, for end-to-end alignment and abutment of optical fibers. The present invention is applicable to all optical fiber connections, including mechanical splice, optical adaptor, optical connector and the like. The term connector will herein be used for convenience, although the skilled person will appreciate the present invention will find utility with all like devices. For example, the term ferrule may appear herein and is not to be taken as a limiting use.

In one embodiment, the connector of the present invention comprises a connector comprising shape memory material such as a shape memory alloy, an optical fiber conduit and an axial stress opening traversing the connector from the connector surface to the fiber conduit and along at least a portion of a longitudinal length of the connector. The fiber conduit is dimensioned for optical fibers and to secure two optical fibers in abutment alignment for light signal transmission from one fiber to the other, with minimal attenuation and for securing the fibers without crushing or other damage to the fibers.

In another embodiment, the present invention relates to a method of bringing optical fibers in abutment connection for signal conduction using a connector as above, wherein a wedging force is applied to the stress opening, whereby the wedging force will induce separation of the side walls of the slot and expansion of the fiber conduit for insertion of optical fibers and their abutment connection and securing of the fibers in abutment connection, when the wedging force is removed. Alternatively, a force may be applied to either side of the stress opening to again expand the opening and fiber conduit for the purpose of placement of optical fibers within the fiber conduit. Removal of the force will allow retention of the fibers in abutment connection of the fibers.

In a still further embodiment, the stress opening as aforesaid, transverses the fiber conduit, opposite the stress opening.

In a still further embodiment, the present invention relates to a connector comprising shape memory material and comprising multiple fiber conduits, connector stress openings and intermediate stress openings, intermediate to the connector slots, whereby multiple pairs of fibers are brought and retained in abutment connection as aforesaid.

In a still further embodiment, the present invention relates to a connector as above comprising one or more conduit of varying diameter and one or more slots in communication with and perpendicular to a connector stress opening.

In a still further embodiment, the present invention relates to an apparatus which applies a wedging force to a stress opening for expansion of a fiber conduit and insertion of optical fibers and their retention, light transmission abutment and connection in a connector as above.

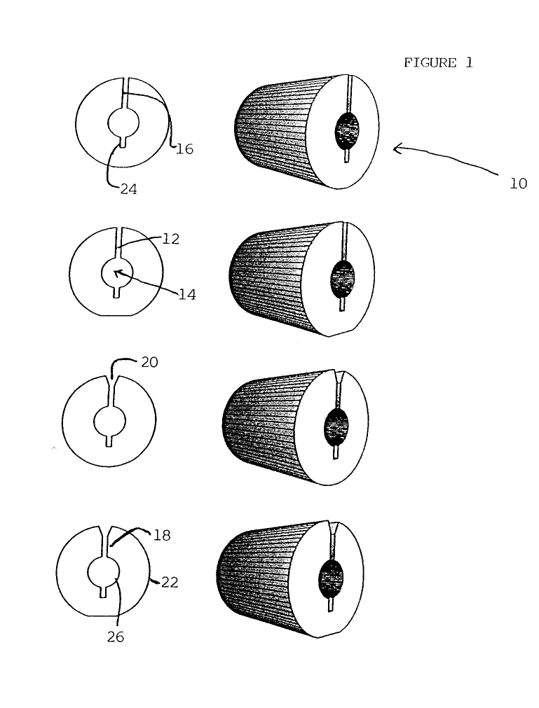

FIG. 1 illustrates a simplified connector of the present invention with single fiber conduit and connector slot, in representative embodiments.

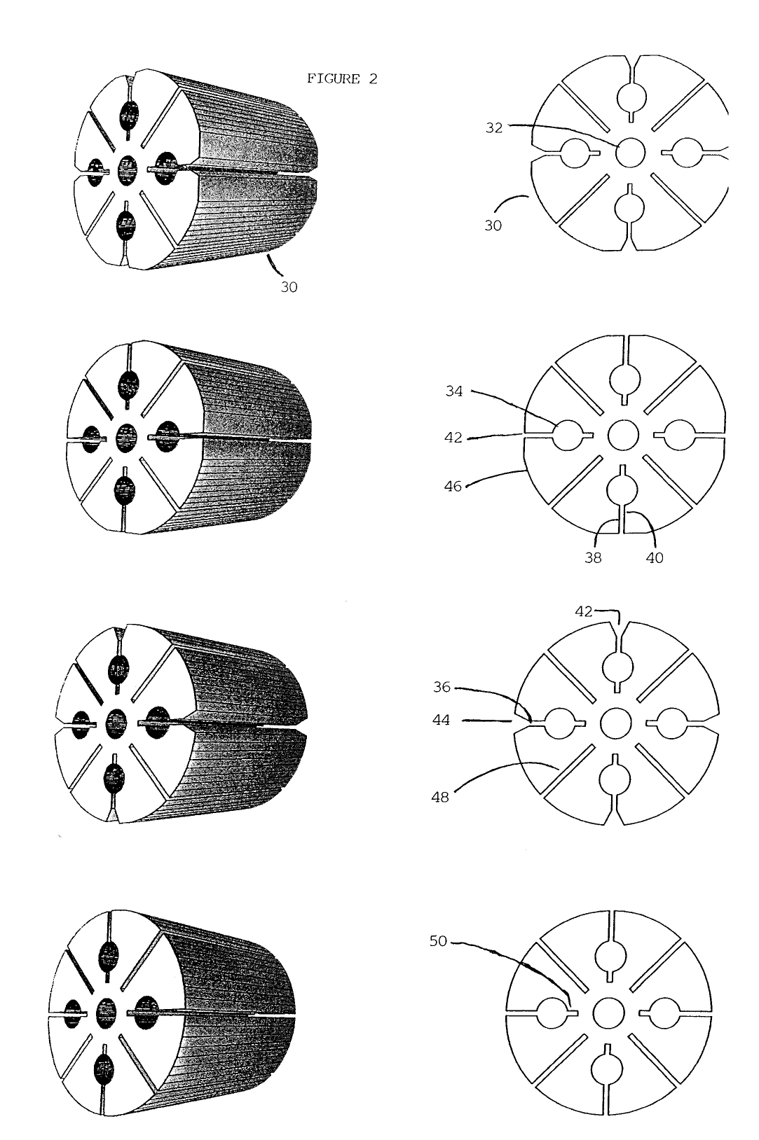

FIG. 2 illustrates representative embodiments of a connector of the present invention with multiple fiber conduits.

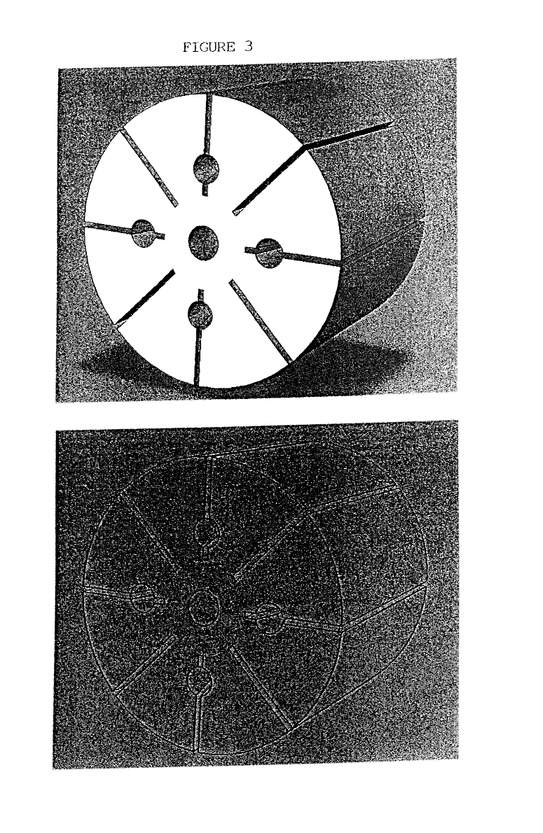

FIG. 3 illustrates a larger image of an embodiment of FIG. 2.

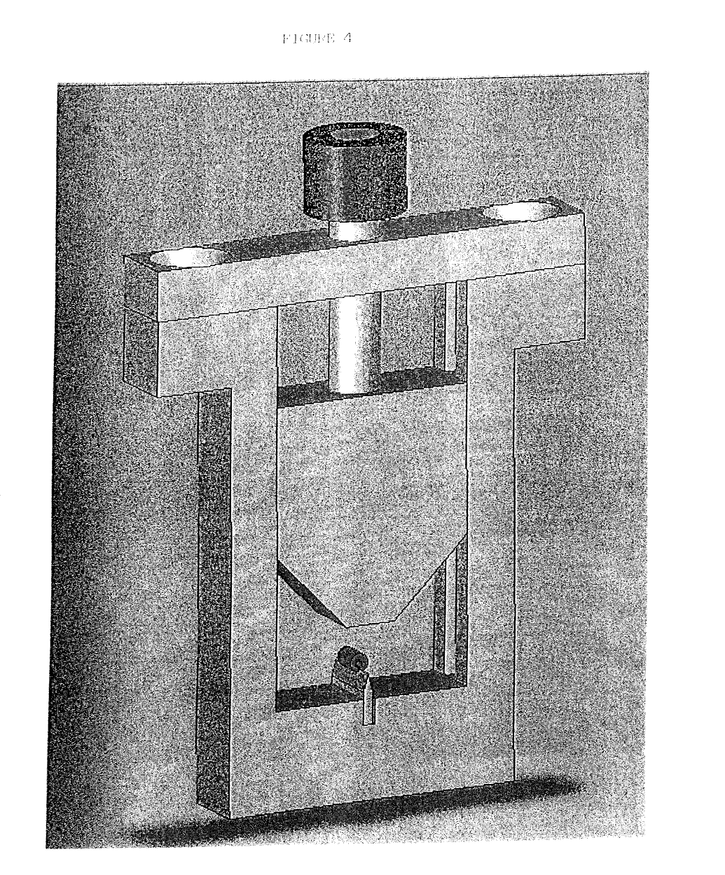

FIG. 4 illustrates one representative simplified embodiment of a tool and method for applying force to achieve insertion and abutment connection of optical fibers with a connector of FIG. 1.

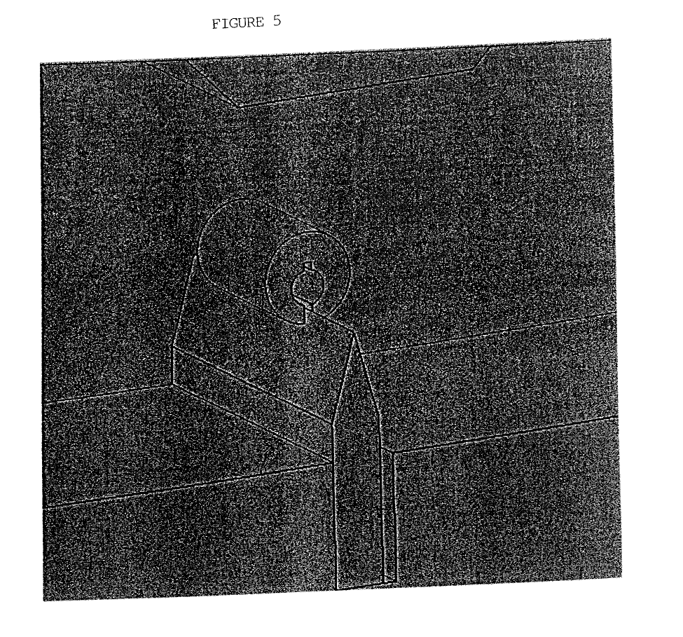

FIG. 5 illustrates an enlarged view of a portion of An apparatus of FIG. 4 with connector.

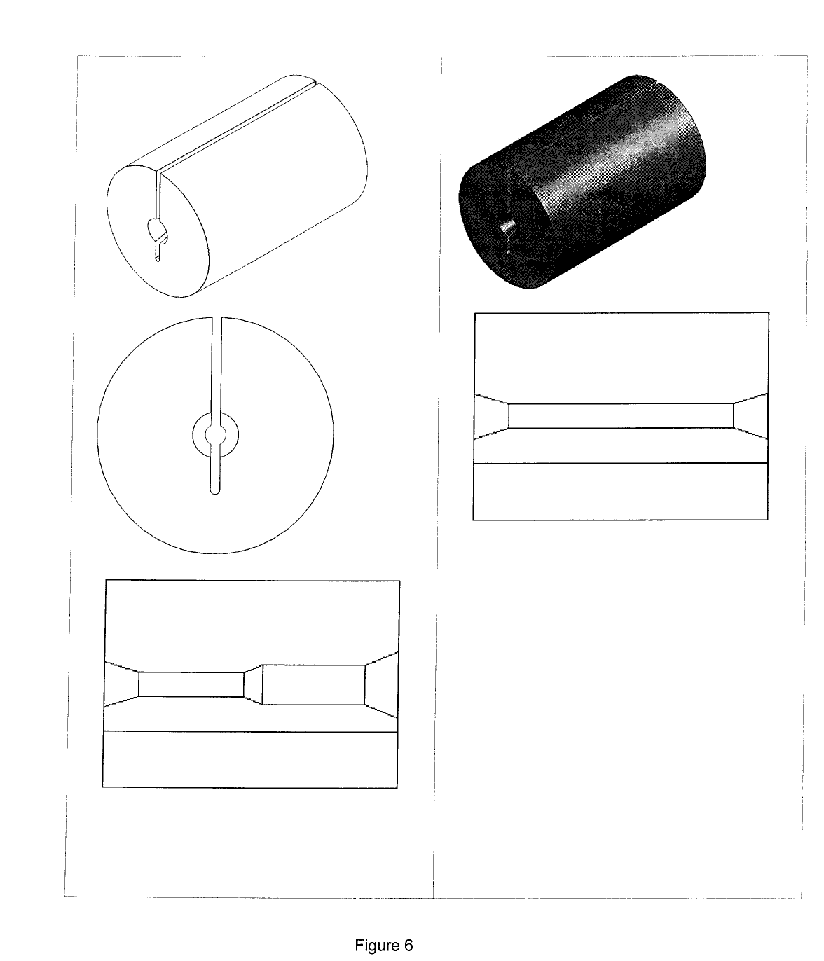

FIG. 6 illustrates a simplified connector of the present invention with varying conduit diameters.

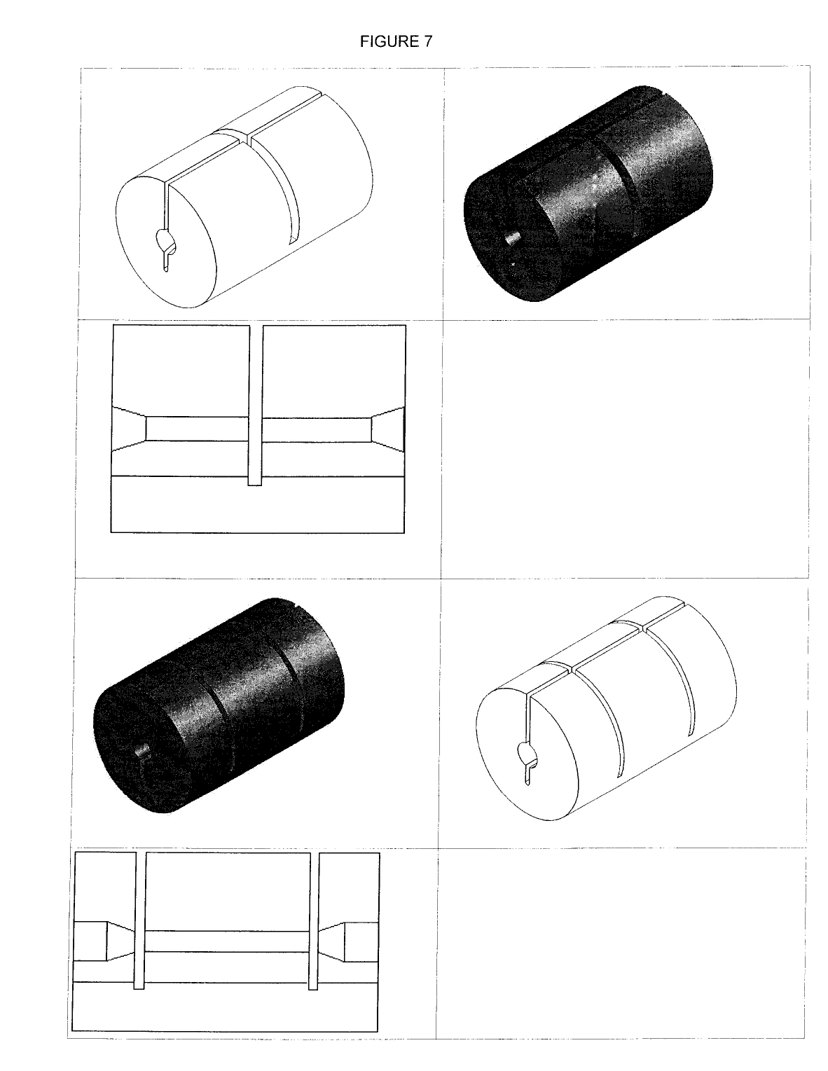

FIG. 7 illustrates a simplified connector of the present invention with one or two perpendicular slots.

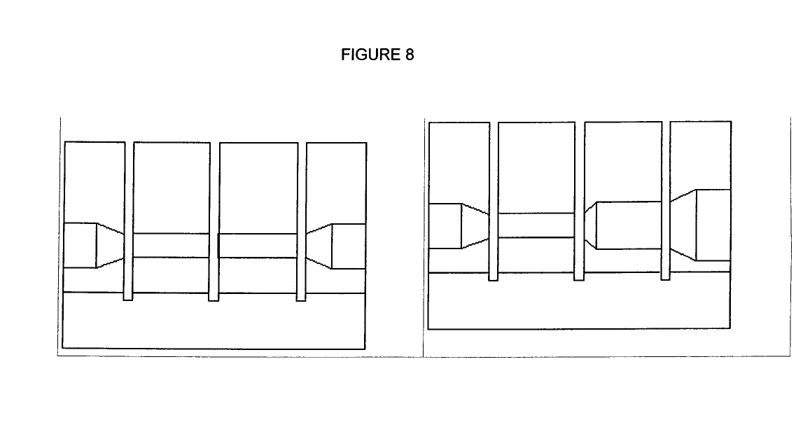

FIG. 8 illustrates a simplified connector of the present invention with three perpendicular slots.

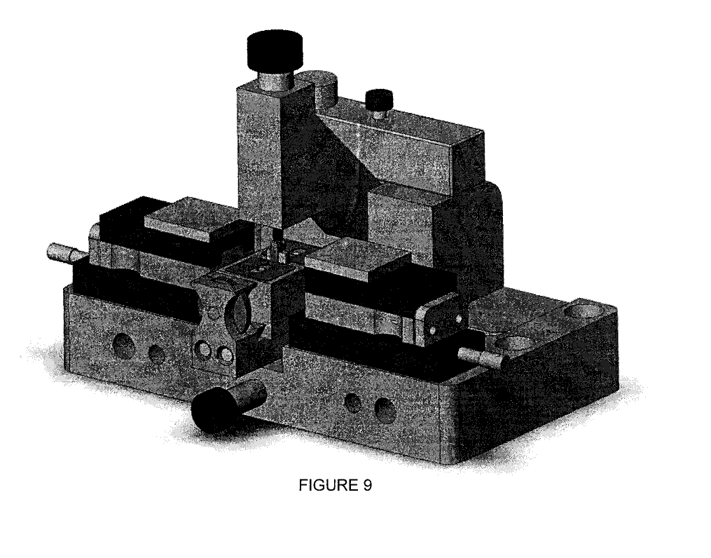

FIG. 9 illustrates an isometric view of another embodiment of an apparatus to achieve insertion and optical connection of fibers with a connector of the present invention.

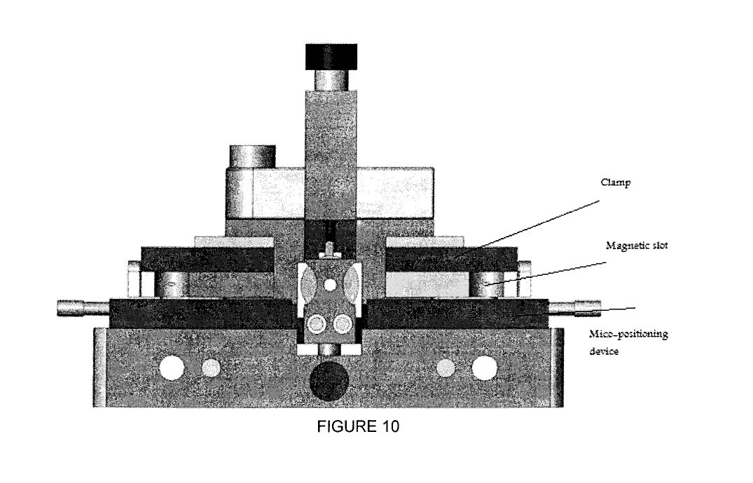

FIG. 10 illustrates a front view of the apparatus of FIG. 9.

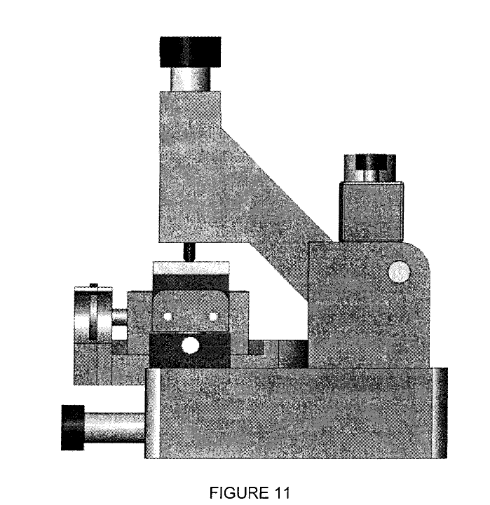

FIG. 11 illustrates a right view of the apparatus of FIG. 9.

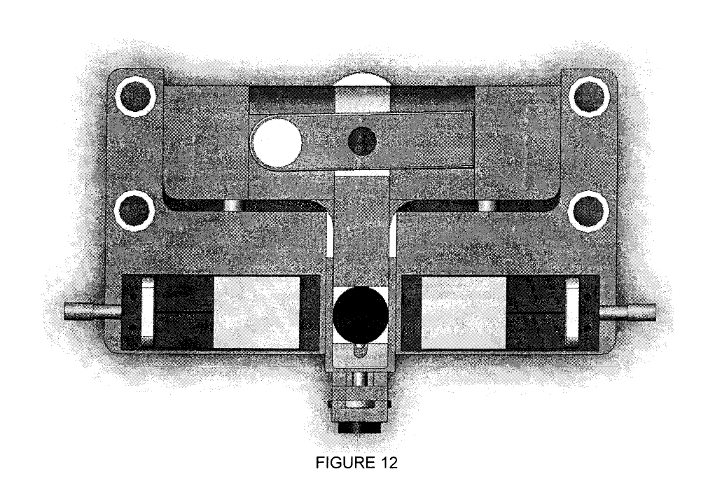

FIG. 12 illustrates a top view of the apparatus of FIG. 9.

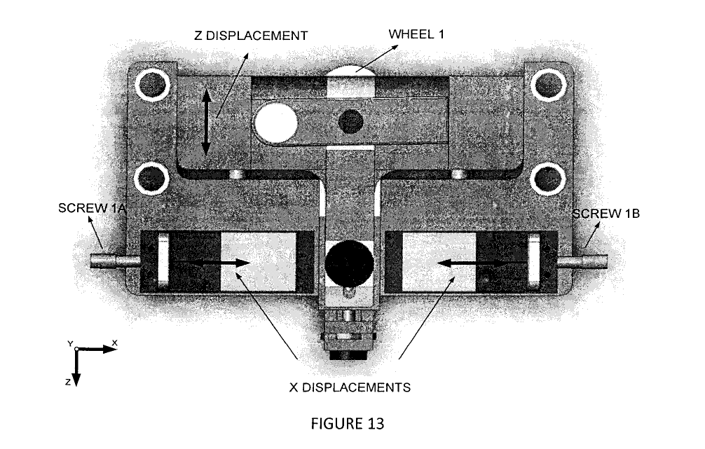

FIG. 13 illustrates a top view of the components of the apparatus of FIG. 9.

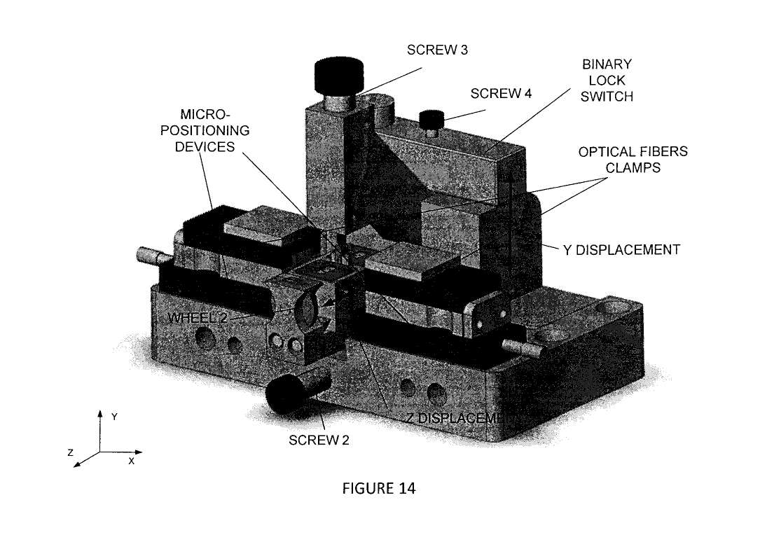

FIG. 14 illustrates an isometric view of the components of the apparatus of FIG. 9.

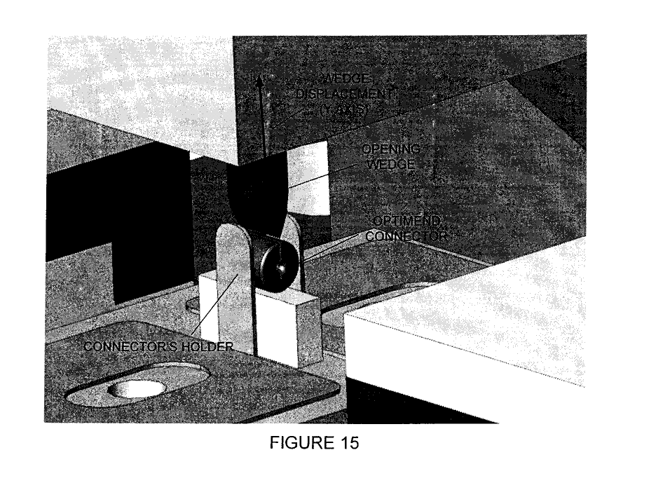

FIG. 15 illustrates the opening mechanism of the apparatus of FIG. 9.

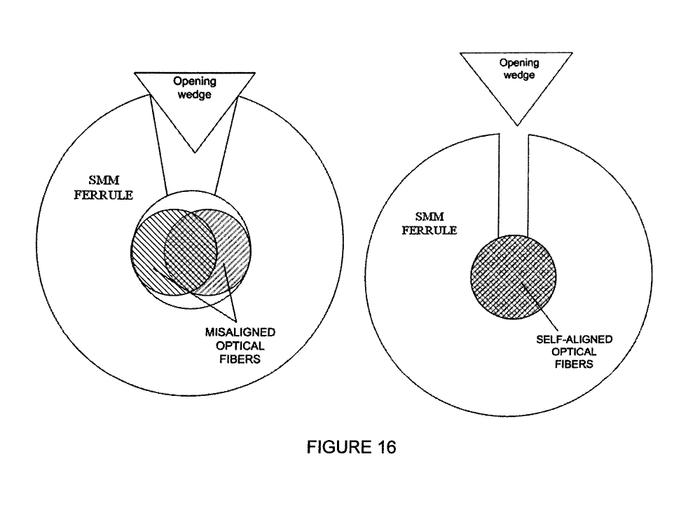

FIG. 16 illustrates the opening principle of the apparatus of FIG. 9.

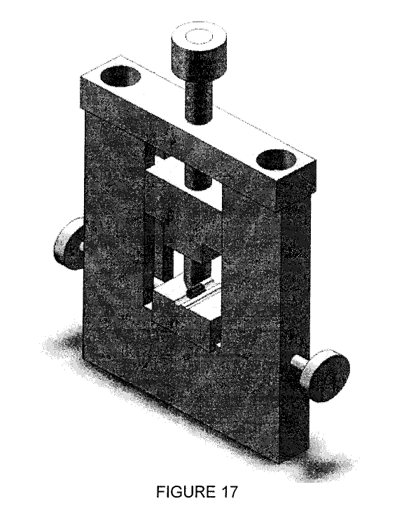

FIG. 17 illustrates a further representative simplified embodiment of an apparatus for insertion and optical connection of fibers with a connector of the present invention.

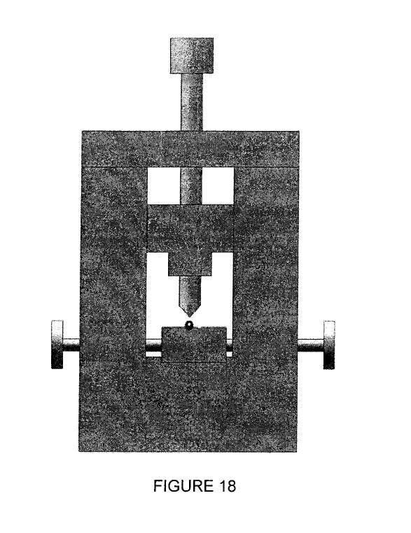

FIG. 18 is a front view of the apparatus of FIG. 17.

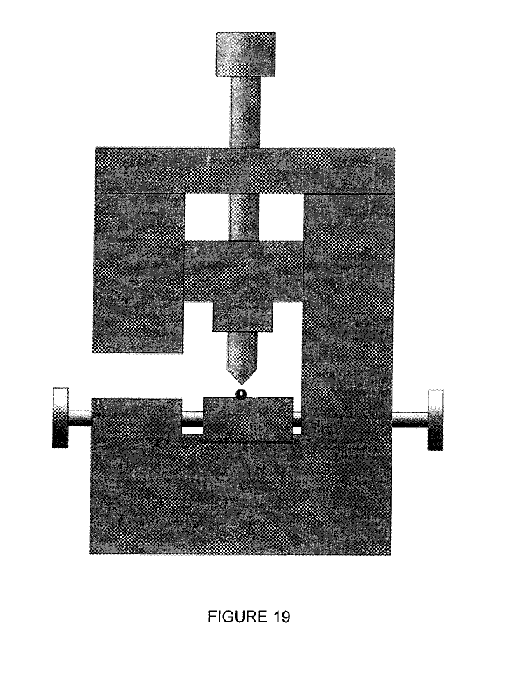

FIG. 19 is a front view of the apparatus of FIGS. 17 and 18 with a frame notch to simplify removal of connected fibers.

### DESCRIPTION

### Shape Memory Alloys (SMA) are Characterized by the Following Behaviour

Shape memory alloys can exist in a two different temperature/stress-dependent crystal structures (phases) called martensite (lower temperature) and austenite (higher temperature). When austenite shape memory alloy is allowed to cool, it begins to change into martensite. The temperature at which this phenomenon starts is called martensite start temperature (Ms). The temperature at which martensite is again completely reverted is called martensite finish temperature (Mf). When the shape memory alloy in martensite phase is heated, it begins to change into the austenite phase. The temperature at which this phenomenon starts is called austenite start temperature (As). The temperature at which this phenomenon is complete is called austenite finish temperature (Af).

The temperature range for the martensite-to-austenite transformation, i.e. soft-to-hard transition that takes place upon heating is somewhat higher than that for the reverse transformation upon cooling.

Mechanical Behaviour of Shape Memory Alloy (SMA) when it is Submitted to Mechanical Stress in the Austenite Phase:

SMA exhibits a pseudo-elastic properties coming from its shape memory characteristics: the transformation from austenite to martensite can be accomplished by stress. Pseudo elastic property is also referred to as super elastic effect.

As shown in the graph below, it can be seen that a normal elastic metal of whatever device has a normal position or initial configuration (shape) as indicated at A, and under stress, moves to a deformed shape that exceeds the elastic limit (Se) of the material as indicated by B. When stress is removed, there is some relaxation of the stressed metal, but it remains permanently deformed in a second configuration, as indicated at C. For such normal elastic materials, the elastic strain (until curve reaches Se) is limited to some 1 to 3%.

The pseudo-elasticity results from the following phenomenon: when the SMM is at a temperature greater than (Af), it can be strained at particularly high rates, that is exhibiting unusual elasticity, arising from the shape memory properties. Initially, when the SMM is stressed the strain will increase linearly, as in a normal elastic material.

However, at an amount of stress, called Sms, which is dependent on the particular SMA and temperature, the ratio of strain to stress is no longer linear, since strain increases at a higher rate as stress increases at a lower rate. At a higher level of stress, called Smf the increase in strain will tend to become smaller. On the release or reduction of stress, the reduction in strain will follow a similar curve from the one manifested as stress was increased, but with an offset, in the manner of a hysteresis like loop.

Sms and Smf are proportional to the difference between the temperature of the SMA, T₁ and respectively Ms and Mf.

Sms and Smf increase are typically 2 MPa per degree Celsius for copper based SMA.

Referring to FIG. 1, this illustrates non-limiting examples of embodiments of a connector (10) of the present invention for connecting two single fibers by abutment connection, comprising a connector stress opening shown as slot (12). Connectors of this embodiment may include one or more perpendicular circumferential slots between the surface of the connector and the fiber conduit (not shown in FIG. 1). The fiber conduit (14), although shown as round, may be any shape suitable for insertion and retention of fibers alone or fibers with any cladding or coating or jacket as may be known in the art. As well, although the connector body is shown in cylindrical or fructo-conical shape, again, the connector body may be any shape that is suitable.

The connector slot has opposing walls (16, 18) and in one embodiment may include a flared or tapered opening (20) near the connector surface (22). The slot as illustrated in one embodiment, traverses the fiber conduit opposite the slot opening, partially through the wall of the connector. Such partial slot (24) need not be opposite the connector slot and if present, may be in a suitable position in the connector wall (26) and along the fiber conduit.

Referring to FIG. 2, illustrated are various embodiments of a multiple fiber conduit connector (30) of the present invention. The fiber conduits in the connector body may be circular or any other shape suitable for abutment connection of optical fibers. A central fiber conduit (32) is shown, although such central fiber conduit need not be present. If present, it may be circular or of any other suitable shape. The embodiments illustrate four fiber conduits (34) in circumferential arrangement about a central longitudinal axis of the connector body at approximately ninety degrees to each other. However, the circumferential fiber conduits of the connector may be in any other suitable number and location for arrangement in the connector body.

Although the multiple fiber connector body is shown as cylindrical, it may be of any shape which is suitable for such a connector. As shown, the connector surface may be at least in part flat.

Associated with each fiber conduit is a conduit slot (36) with opposing walls (38, 40) traversing the outer surface of the connector to the conduit. Each slot may traverse the fiber conduit it is associated with. As well, the mouth (42) of the slot may be tapered (44) at or near the surface (46) of the connector. Intermediate slots (48) are also present in the connector, intermediate of fiber conduits. Again, the multiple fiber connector is shown as cylindrical, although it may be in any suitable shape. A connector slot may traverse the fiber conduit as a partial slot (50). One or more perpendicular, circumferential slots (not shown) may be present in a multiple fiber connector.

FIG. 3 illustrates one embodiment of a multiple fiber connector, wherein the fiber conduit openings are not flared or tapered.

Where a multiple fiber connector includes a fiber conduit in the middle, the ends of two optical fibers with gel suitably applied may be inserted with the necessary precision in any manner as described in anyone or all of the above approaches, and in a manner known to a person skilled in the art and relying on common general knowledge.

Placement of optical fibers in abutment connection in a circumferential fiber conduit will be by exertion of a wedging force or by application of a force displacing apart the walls of the conduit slot sufficient to expand the fiber conduit to allow positioning of fibers, whether coated, clad or uncoated or unclad, or with a jacket, in abutment connection. Again, the precision of the placement of the optical fiber ends appropriate for abutment connection will be by means as previously described in the above approaches and by means known to a person skilled in the art. The suitable stress to be applied to a conduit slot and dimensions and configurations of conduit and intermediate slots will at least in part depend on the pseudo-elastic properties of the shape memory material, as would be understood by a skilled person.

Referring to FIGS. 4 and 5 with illustration, as a non-limiting example, of a single fiber connection conduit, a wedging force may be applied to the conduit slot by stress tool (52) to separate the conduit walls and create a deformation of the fiber conduit, by expanding the fiber conduit to permit placement and precision abutment positioning of the ends of two optical fibers. In a similar fashion, not illustrated, the fiber conduits in a multiple fiber conduit connector may be deformed serially or simultaneously for placement of two fibers in abutment connection in each fiber conduit. The intermediate slots in the walls of the connector for multiple fiber conduits allow, along with the conduit slots, deformation, based on the pseudo-elastic properties of the material, of the conduit wall for placement of optical fibers in abutment connection in each of the fiber conduits, when force or stress is applied and secure retention without damage to fibers when the force or stress is removed. Further description of another non-limiting embodiment of an apparatus of the present invention is provided later in the present description.

Although the slots, as shown and described in the embodiments above are with parallel or generally parallel walls, it will be understood by a skilled person that both the conduit and intermediate stress openings may be any suitable shape and configuration other than as a slot, for the intended purpose. As well, a skilled person will appreciate that conduits will be dimensioned suitably to permit entry and retention in optical abutment connection of optical fibers while avoiding damage to fibers regardless of the material, whether glass, plastic or hybrid, from which they are made regardless of the absence or presence of coating or cladding or jacket, and that the fiber dimension and material are not essential features hereof.

A fiber conduit according to the connector of the present invention may be of non-uniform diameter or cross-section from a one face end of a connector body to another face end. That is, a conduit may be dimensioned for entry, retention and abutment of two fibers of different diameters. FIG. 6 is a non-limiting example of a single conduit for abutment of fibers of different diameter. Likewise, the conduits of a multiple fiber connector of the present invention may each be of non-uniform diameter or cross-section from one end of the connector body to the other. For example, an embodiment such as in FIG. 6 may be used for abutment of a fiber of 125 μm diameter with a fiber of 230 μm diameter, or for abutment of the end of one fiber with the end of another fiber bearing its protective coating.

In another aspect of the connector of the present invention, a connector will include one or more perpendicular circumferential slot, perpendicular to each of said stress opening slot. Such perpendicular slots will permit the independent opening and closing of each end of the connector conduit or of different parts of a connector conduit. This will permit insertion or removal of one fiber without disturbing the other fiber in a same conduit. Such perpendicular slots may be present in a connector of the present invention with one or more circumferential conduit on a multiple conduit connector as described above. Again, one or more perpendicular slots may be associated with each conduit.

FIG. 7 illustrates a simplified non-limiting example of a single conduit with one or two perpendicular slots. With a perpendicular slot, the retention by pressure of each fiber in a conduit is independent of the other fiber. This permits, for example, a different pressure in the portion of a conduit retaining a protection coated fiber from the portion of a conduit retaining a fiber alone, in alignment and in abutment with the other fiber. The retention pressure can then be controlled and be a function of the depth of the perpendicular slot, connector slot and/or the diameter of the conduit. For connectors for multiple fiber conduits, the perpendicular slot will extend to the intermediate slots to permit the independent deformations, for placement and securing as described above.

FIG. 8 illustrates a simplified non-limiting example showing a single conduit with three perpendicular slots. A three slot arrangement can be used for abutment connection of two fibers of different diameter and/or protective covering of different thickness, as the conduit diameter or cross-section may vary accordingly, along the length of the conduit, from one end of the connector to the other. In this way, a specific conduit diameter and cross-section profile will be associated with a particular conduit from one end to the other end, depending on the dimensions of the inserted fibers and covering.

In the case of a multiple fiber connector, it will be understood that the conduits may be of the same or different diameter and may be of same or different diameter or cross-section profile, from end to end. It will also be understood that when two or more perpendicular slots are present, they may all be of the same or different distance between the slot walls and of the same or different depth.

### Apparatus

In another embodiment the present invention relates to an installation apparatus used to connect two optical fibers in a single shape memory alloy connector as above. Below and with reference to FIGS. 9 to 19 is provided a non-limiting exemplary description of one embodiment for such an apparatus and of a procedure leading to fiber connection.

### Description of the Apparatus

The described apparatus is used to connect two optical fibers in a shape memory alloy connector. This may be by example an Optimend™ connector or any connector as previously herein described. The functions of the apparatus being to:
1. Maintain the connector in place
2. Open the connector to allow optical fibers insertion
3. Align and insert both optical fibers in a connector conduit.

Table 1 below and the following disclosure and FIGS. 9 to 19 provide a description of the displacement and other components of the exemplary apparatus.

TABLE 1
List of adjustments and mobile parts

| Part | Action |
|---|---|
| WHEEL 1 | Allows height adjustment |
| | (Y displacement) |
| WHEEL 2 | Allows independent longitudinal displacement of the connector |
| | (Z displacement) |
| SCREW 1A&1B | Allow control of the micro-positioning devices |
| | (X displacements) |
| SCREW 2 | Allows longitudinal displacement of connector and opening device |
| | (Z displacement) |
| SCREW 3 | Allows height control of the opening wedge |
| | (Y displacement) |
| SCREW 4 | Acts as a lock screw on the binary switch |
| BINARY LOCK | Locks the opening wedge vertically |
| SWITCH | |
| OPTICAL | Maintain a constant hold on the optical fibers |
| FIBERS | |
| CLAMPS | |
| MICRO- | Allows the insertion of the optical fibers in and out of the connector |
| POSITIONING | |
| DEVICES | |
| OPENING | Allows the Optimend* connector to open |
| WEDGE | |
| CONNECTOR'S | Maintain the Optimend* connector stable during the insertion process |
| HOLDER | |
| OPTIMEND* | Allows the mechanical connection of two optical fibers |
| CONNECTOR | |

*™

### Description of the Procedure:

The first step leading to the mechanical connection is to clean the connector by sinking it for a few seconds into suitable fluid, for example alcohol and then blowing compressed cleaning gas inside the center hole of the connector. Next step consists in the insertion of the connector in its holding stage at the center of the apparatus. To simplify the alignment process, the longitudinal slit of the connector is oriented upward (FIG. 15) so that the opening wedge can easily be inserted in the slit afterwards. The opening arm (FIG. 9, 11) is then locked down (SCREW 4) using the binary lock switch ensuring the verticality of the opening wedge and proper position of the wedge during alignment of the optical fibers as described further, below. Using the proper Z axis displacement (FIG. 14, WHEEL 2), the slit is aligned under the opening wedge tip. When the alignment is proper, the opening wedge is lowered down in the slit using the height adjustment screw (FIG. 14, SCREW 3) until the center hole of the ferrule is opened of a few microns (Y displacement). The opening wedge acts a pressure zone and allows the connector to open.

Before using the apparatus any further to connect the optical fibers inside the connector, standard fiber preparation is required. However, such standard fiber preparation is not to be regarded as an essential feature of the present invention and is included here for exemplary purposes. The optical fiber's preparation procedure starts with the stripping of fiber's jacket on both fibers end to be connected. The stripping length is between 20 mm and 30 mm. The next step is to clean the stripped part of both fibers with, for example, isopropanol, or any other cleaning liquid commonly used for fiber cleaning, and a fiber cloth. Fibers are then inserted in their respective optical fiber clamp. These clamps (FIG. 10, 14) are chosen depending on the type of fiber that needs to be mechanically connected with, for example, an Optimend™ connector. The clamps as will be understood, must fit the outer diameter of the unstripped fiber. For example: In case a SMF-28-SMF-28 connection, the clamps used are made for holding a 250 μm diameter optical fibers. Once both fibers are tightly held in place in their respective clamp, they may be successively cleaved as may be required with a high-quality optical fiber cleaver that guaranties a low cleave angle. The clamps used to hold the fibers must ideally fit in the optical fiber cleaver to guaranty the fiber alignment inside the cleaver from time to time.

When cleaved, the optical fibers are kept in their clamp and are placed on the apparatus. The clamps will be coupled to the apparatus by any suitable mechanical means, such that the fibers may be moved and positioned for placement in the connector for optical connection. For example the clamps may be coupled to the micro-positioning device by means of magnetic slots on the apparatus (FIG. 10, 14) but as noted, this may be by way of any suitable clamp holding means, for this purpose. Using for example either cameras with a proper zooming optic or any optical system capable of magnifying the center hole (conduit) of the, for example, Optimend™ connector, one of the two optical fibers (without preference) is aligned (X and Z displacement) in the center of the ferrule's hole using WHEEL 1, SCREW 1A & 1B and SCREW 2 (FIG. 12, 13, 14). When properly aligned, the optical fiber is gently inserted throughout the ferrule until the cleaved face of the fiber is approximately coincident to the connector face using the micro-positioning devices. The second optical fiber is then aligned and approached to the first one using the preceding technique, using WHEEL 1, SCREW 1A & 1B and SCREW 2 (FIG. 12, 13, 14). When the second fiber is aligned with the first one, the first fiber is move backward in the center of the connector. The other fiber is subsequently moved forward in the middle of the ferrule. The contact of the cleaved surface of both fibers is detected by the creation of a bend in one of the fibers. A small bend for example is maintained since it has proven to upgrade the power transfer efficiency when the connector is closed because it guaranties that the contact will be maintained between the fibers when the opening wedge is removed. If the bend is too big, the fibers may experience an intense stress as the ferrules closes on them which can lead to the rupture of the fibers. On the other hand, if none of the fibers are bent, it may mean that the fibers are not in contact which could induce additional transmission losses because of the air gap between the fibers cleaved surfaces. Once the insertion of the optical fibers is completed, the opening wedge is removed which allows the ferrule to close around the fibers and maintain them durably in position since the hole (conduit) of the connector is slightly smaller (a few microns) than the optical fibers diameter (FIG. 16). The distributed force applied by the connector on both optical fibers guaranties the alignment of the optical fibers cladding which maximizes the power transmission at the junction of the optical fibers. Finally, the opening arm (FIG. 9, 11) of the exemplary apparatus is unlocked and moved away from the connector and the fibers are unclamped so that the connection can be removed from the apparatus.

A skilled person will appreciate that the aforesaid description and procedure will apply with routine mechanical variations to multiple optical fiber connectors as previously described and the positioning and alignment of multiple pairs of optical fibers therein. For example, such procedure may involve simultaneous or consecutive, serial manipulation of fibers, individual fiber conduits and stress slots as hereinabove described.

A further simplified version (FIG. 17, 18, 19) of an apparatus may be used to connect optical fibers for example with diameter above 230 μm. Optical fibers with a large diameter such as plastic optical fibers and some multimode optical fibers are more friendly to connect in a mechanical connector because of their size. For instance, a simpler apparatus may be used to connect them. Working under the same opening mechanism, that is insertion of a wedge to the connector slot to open the fiber conduit, this apparatus may not require the use of micro-positioning devices found on the previous apparatus, since the optical fibers can easily be connected by hand inside the opened connector. Optical fibers may still undergo the same preparation process of stripping, cleaning and cleaving before being connected. However, it will be understood stripping may not be required for plastic fibers. Two adjustments are mounted on the described apparatus. The first one consists in a translation displacement (horizontal) driven by a screw at the bottom of the frame that allows the alignment of the connector with the upper opening wedge. The second one is also driven by a screw and controls the height (vertical) of the wedge, allowing the opening and closing of the ferrule.

FIG. 19 illustrates a modified apparatus with a frame notch for simplified removal of connected fibers from the apparatus.

It is to be understood that the various features of the present invention might be incorporated into other types of connector devices or installation apparatus and that other modifications or adaptations may occur to workers in the art and it is to be understood that the invention is not to be limited to the specific embodiments disclosed and that modifications and other embodiments are intended to be included within the scope of the appended claims. All such variations and modifications are intended to be included herein as being within the scope of the present invention as set forth. Further, in the claims herein, the corresponding structures, materials, arts and equivalence of all means or step plus function elements are intended to include any structure, material or acts for performing the functions in combination with other elements as specifically claimed.

What is claimed is:

1. An optical fiber connector, for connection of the ends of two optical fibers for transmission of a light signal with minimum attenuation, comprising an optical fiber conduit and a stress opening traversing from a surface of said connector to said conduit.

2. An optical fiber connector, for connection of the ends of two or more pairs of optical fibers for light signal transmission with minimum attenuation from one to the other fiber of each pair, comprising: two or more optical fiber conduits, at least one conduit circumferential to an axis of said connector, a conduit stress opening associated with each said conduit, traversing from a surface of said connector to said conduit and when there are two or more conduit stress openings, one or more intermediate stress opening, each intermediate stress opening intermediate two conduit stress openings.

3. An optical fiber connector according to claim 2, wherein the diameter or cross-section of at least one conduit varies from a first end to a second end of said connector.

4. An optical fiber connector according to claim 2, wherein at least one perpendicular slot is associate with at least one of said stress opening.

5. A method for end-to-end optical connection of optical fibers comprising application of a force to a conduit stress opening of a connector as defined by claim 1, sufficient to force apart opposing faces of said stress opening, inserting one fiber into one end of a conduit and another fiber into the other end of said conduit, positioning the ends of said fibers into end-to-end light transmission connection, and releasing said force to secure said fibers in end-to-end connection.

6. An apparatus for end-to-end optical connection of optical fibers in an optical fiber connector as defined by claim 1, comprising connector holding means, stress opening wedge means and wedge displacement means for displacement of said stress opening wedge means.

7. The apparatus of claim 6 further comprising optical fiber clamp means and optical fiber micro-positioning means.
